(19) United States
(12) Patent Application Publication
(10) Pub. No.: US 2006/0050046 A1
(43) Pub. Date: Mar. 9, 2006

(54) Liquid crystal display panel and method for making it

(75) Inventors: Che-Kuei Mai, Miao-Li (TW); Kai Meng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/173,391

(22) Filed: Jun. 30, 2005

(30) Foreign Application Priority Data
Sep. 3, 2004 (TW) 93126630

(51) Int. Cl. G09G 3/36

(52) U.S. Cl. 345/100

(57) ABSTRACT

A liquid crystal display panel (100) includes a first substrate (110), a second substrate (120) opposite to the first substrate, a driving integrated circuit chip (140), and a connector (170). The driving integrated circuit chip and the connector are set on the second substrate. Thus, costs are economized. In addition, the problems of fragility and unreliable connectivity inherent with flexible printed circuit boards, are avoided. Comparing with the typical liquid crystal display panel, the liquid crystal display panel has a better display quality.

### FIELD OF THE INVENTION

The present invention relates to liquid crystal display panels and methods for manufacturing liquid crystal display panels.

### BACKGROUND

Referring to FIG. 6, a typical liquid crystal display panel is shown. The liquid crystal display panel 10 includes a first substrate 11, a second substrate 12, a driving integrated circuit chip 14, a plurality of first wires 15, a plurality of second wires 16, a flexible printed circuit board 18, and a connector 17.

The first substrate 11 is set opposite to the second substrate 12. The second substrate 12 includes the first wires 15 and the second wires 16. The driving integrated circuit chip 14 is set on the second substrate 12. The driving integrated circuit chip 14 is connected with the first wires 15 for generating images on a display region 13. The connector 17 is set on the flexible printed circuit board 18. The driving integrated circuit chip 14 is connected with the flexible printed circuit board 18 through the second wires 16.

The connector 17 is connected with a computer or any of various other kinds of electronic devices (not shown). The computer sends out a control signal, and the control signal is conveyed to the driving integrated circuit 14 through the flexible printed circuit board 18 and the second wires 16. Thus, the display region 13 can display an image.

In the liquid crystal display panel 10, the connector 17 is set on the flexible printed circuit board 18, and the flexible printed circuit board 18 is connected with the second substrate 12 through the second wires 16. By its very nature, the flexible printed circuit board 18 is liable to damaged or provide faulty connection, particularly in situations where the liquid crystal display panel 10 is subjected to vibration or shock. Thus, the quality or reliability of the images displayed by the liquid crystal display panel 10 may be impaired.

What is needed, therefore, is a new liquid crystal display panel which can overcome the above-described problems.

### SUMMARY

In one embodiment, a liquid crystal display panel comprises a first substrate, a second substrate opposite to the first substrate, a driving integrated circuit chip, and a connector. The driving integrated circuit chip and the connector are set on the second substrate.

Because the connector is set directly on the second substrate, there is no need for a flexible printed circuit board connected with the connector and the driving integrated circuit chip. Thus costs are economized. In addition, the problems of fragility and unreliable connectivity inherent with flexible circuit boards, are avoided. Comparing with the typical liquid crystal display panel, the liquid crystal display panel can have a better display quality.

Other advantages and novel features will become more apparent from the following detailed description when taken in conjunction with the accompanying drawings.

### BRIEF DESCRIPTION OF THE DRAWINGS

FIG. 1 is an isometric view of a liquid crystal display panel according to a preferred embodiment of the present invention.

FIG. 2 is a similar to FIG. 1, but showing the liquid crystal display panel with a display region thereof removed.

FIG. 3 is a cross-sectional view corresponding to line III-III of FIG. 2.

FIG. 4 is a flow chart of an exemplary method for making the assembly shown in FIG. 2.

FIG. 5 is similar to FIG. 2, but showing a precursor of the assembly at one stage during performance of the method according to FIG. 4.

FIG. 6 is an isometric view of a typical liquid crystal display panel.

### DETAILED DESCRIPTION OF PREFERRED EMBODIMENTS

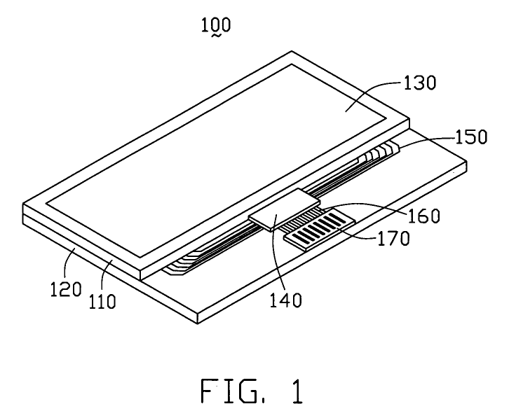

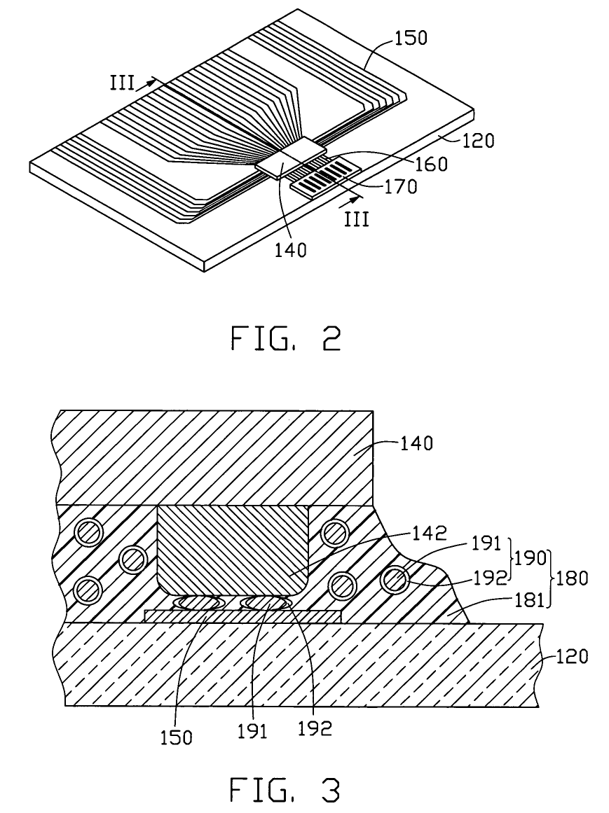

Referring to FIG. 1 and FIG. 2, a liquid crystal display panel according to the preferred embodiment of the present invention is shown. The liquid crystal display panel 100 includes a first substrate 110, a second substrate 120, a driving integrated circuit chip 140, and a connector 170.

The first substrate 110 is set opposite to the second substrate 120. The second substrate 120 includes a plurality of first wires 150 and a plurality of second wires 160. The driving integrated circuit chip 140 is set on the second substrate 120. The driving integrated circuit chip 140 is connected with the first wires 150 and the second wires 160 for generating an image on a display region 130. The connector 170 is set on the second substrate 120. The connector 170 is connected with the driving integrated circuit chip 140 through the second wires 160.

Referring to FIG. 3, this shows parts of structures between the first and second substrates 110, 120. The first wires 150, which are set in the second substrate 120, are connected with a metal protrusion 142 of the driving integrated circuit chip 140 through an anisotropic conductive film 180. The anisotropic conductive film 180 includes an organic bond 181 and a multiplicity of deformable particulates 190. The deformable particulates 190 are spread randomly but generally uniformly throughout the organic bond 181. Each deformable particulate 190 includes an electrically conductive core 191 and an insulating shell 192. The insulating shell 192 surrounds the conductive core 191. The conductive core 191 can be made of metallic material. The insulating shell 192 can be made of resinic material.

When the driving integrated circuit chip 140 is set on the second substrate 120, the metal protrusion 142 of the driving integrated circuit chip 140 is pushed into the anisotropic conductive film 180. Some of the deformable particulates 190 that are under the metal protrusion 142 are squeezed between the metal protrusion 142 and the first wires 150, and the insulating shells 192 of these deformable particulates 190 burst. Therefore the metal protrusion 142 comes into electrical contact with the conductive cores 191 of the deformable particulates 190, and the first wires 150 also come into contact with the same conductive cores 191. That is, the metal protrusion 142 establishes electrical contact with the first wires 150 through the conductive cores 191.

In the same way, the driving integrated circuit chip 140 establishes electrical contact with the second wires 160 through the anisotropic conductive film 180. Thus the connector 170 is in electrical contact with the second wires 160 through the anisotropic conductive film 180.

In use, the connector 170 receives a signal from a computer or any of various other kinds of electronic device (not shown). The connector 170 conveys the signal to the driving integrated circuit chip 140 through the second wires 160. According the signal, the driving integrated circuit chip 140 controls the display region 130 to display images through the first wires 150.

Because the connector 170 is set directly on the second substrate 120, there is no need for a flexible printed circuit board. Therefore costs are reduced. In addition, the problems of fragility and unreliable connectivity inherent with flexible printed circuit boards are avoided. This can improve the quality and reliability of the display produced.

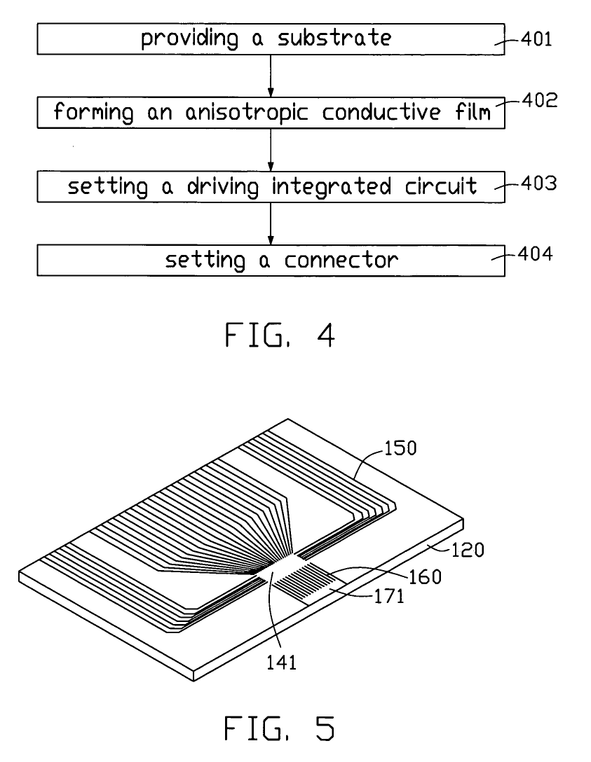

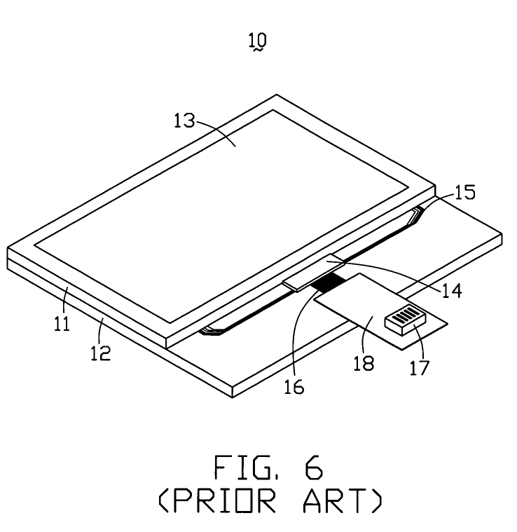

Referring to FIG. 4 and FIG. 5, an exemplary method for making an assembly comprising the second substrate 120 is shown. The method includes four steps.

The first step 401 is providing a second substrate 120. The second substrate 120 includes a plurality of first wires 150 and a plurality of second wires 160. A region 141 for setting a driving integrated circuit chip 140 is left in advance near the first and second wires 150, 160. A region 171 for setting a connector 170 is left in advance near the second wires 160.

The second step 402 is forming an anisotropic conductive film 180. The anisotropic conductive film 180 is formed on the region 141 of the second substrate 120 for setting of the driving integrated circuit chip 140 thereat, and on the region 171 of the second substrate 120 for setting of the connector 170 thereat.

The third step 403 is setting the driving integrated circuit chip 140. The driving integrated circuit chip 140 is set on the region 141 of the second substrate 120. The driving integrated circuit chip 140 is connected with the first wires 150 and the second wires 160 through the anisotropic conductive film 180.

The fourth step 404 is setting the connector 170. The connector 170 is set on the region 171 of the second substrate 120. The connector 170 is connected with the second wires 160 through the anisotropic conductive film 180.

Thus the assembly comprising the connector 170 set on the second substrate 120 is obtained.

It is to be further understood that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display panel, comprising:
a first substrate;
a second substrate opposite to the first substrate;
a driving integrated circuit chip set on the second substrate; and
a connector is set on the second substrate.

2. The liquid crystal display panel as claimed in claim 1, wherein the second substrate comprises a plurality of first wires.

3. The liquid crystal display panel as claimed in claim 2, wherein the first wires are connected with the driving integrated circuit chip through an anisotropic conductive film.

4. The liquid crystal display panel as claimed in claim 1, wherein the second substrate comprises a plurality of second wires.

5. The liquid crystal display panel as claimed in claim 4, wherein the second wires are connected with the driving integrated circuit chip through an anisotropic conductive film.

6. A method for making a substrate assembly of a liquid crystal display panel, comprising:
providing a substrate;
forming an anisotropic conductive film on the substrate;
setting a driving integrated circuit on the substrate; and
setting a connector on the substrate.

7. A liquid crystal display panel, comprising:
a first substrate;
a second substrate stacked upon the first substrate, said second substrate being smaller than the first substrate and only covering a portion of the first substrate;
a driving integrated circuit chip disposed on an unexposed portion of the second substrate; and
a connector is disposed on said unexposed portion of the second substrate and electrically connected to the driving integrated circuit.
